(19) United States
(12) Patent Application Publication
(10) Pub. No.: US 2025/0289507 A1
(43) Pub. Date: Sep. 18, 2025

(54) Inhibiting Debris Accumulation on Vehicles

(71) Applicant: Nissan North America, Inc., Franklin, TN (US)

(72) Inventors: Jason Lyman, Whitmore Lake, MI (US); David Huynh, Windsor (CA)

(21) Appl. No.: 18/603,524

(22) Filed: Mar. 13, 2024

(51) Int. Cl. B62D 25/18; B60J 10/84

(52) U.S. Cl. CPC B62D 25/18; B60J 10/84

(57) ABSTRACT

A vehicle that includes: a vehicle body; vehicle doors that are connected to the vehicle body; sealing members that are positioned between the vehicle body and the vehicle doors to thereby seal the vehicle doors upon closure; and air guides that are connected to the vehicle body. Each air guide includes a body panel that is spaced axially from the corresponding sealing member along a length of the vehicle such that an axial gap is defined therebetween and a flange that extends axially in relation to the body panel at an upper end of the air guide, wherein the flange is configured for positioning within the axial gap to thereby inhibit debris accumulation on the vehicle body.

### TECHNICAL FIELD

The present application relates to air guides for vehicles and, more specifically, to air guides that are configured to inhibit (if not entirely prevent) the accumulation of debris (e.g., dirt, mud, dust, etc.) on the vehicle body.

### BACKGROUND

Debris accumulates on a vehicle body for various reasons. As a result of tire splash, for example, debris tends to accumulate adjacent to the vehicle doors, which often results in the debris being transferred onto a passenger's clothing or person.

The present disclosure addresses this issue by providing air guides that are configured to interrupt airflow and thereby inhibit (if not entirely prevent) debris from bypassing (circumventing) the air guides and accumulating on the vehicle body.

### SUMMARY

In one aspect of the present disclosure, a vehicle is disclosed that includes: a vehicle body; vehicle doors that are connected to the vehicle body; sealing members that are positioned between the vehicle body and the vehicle doors to thereby seal the vehicle doors upon closure; and air guides that are connected to the vehicle body. Each air guide includes a body panel that is spaced axially from the corresponding sealing member along a length of the vehicle such that an axial gap is defined therebetween and a flange that extends axially in relation to the body panel at an upper end of the air guide, wherein the flange is configured for positioning within the axial gap to thereby inhibit debris accumulation on the vehicle body.

In certain embodiments, the air guides may be unitary in construction.

In certain embodiments, the body panel may include at least one strengthening member that extends vertically along a height of the vehicle, wherein the flange is positioned laterally outward of the at least one strengthening member.

In certain embodiments, the body panel may include at least one recess that is configured to receive the vehicle body.

In certain embodiments, the flange may be positioned laterally outward of the at least one recess.

In certain embodiments, each air guide may further include an interface that connects the body panel and the flange.

In certain embodiments, the interface may define an arcuate inner wall to reduce stress concentrations.

In certain embodiments, the flange may extend in generally orthogonal relation to a width of the vehicle.

In certain embodiments, the flange may define a height that varies between a first end and a second end thereof.

In certain embodiments, the flange may be configured such that the height increases from the first end towards the second end.

In certain embodiments, the flange may include a tapered configuration to inhibit vertical gapping with the vehicle body.

In another aspect of the present disclosure, a vehicle is disclosed that includes: a vehicle body; vehicle doors that are connected to the vehicle body; sealing members that are positioned between the vehicle body and the vehicle doors to thereby seal the vehicle doors upon closure; and air guides that are connected to the vehicle body. Each air guide includes a body panel and a flange that is connected to the body panel such that the flange extends between the body panel and the corresponding sealing member along a length of the vehicle to thereby inhibit debris accumulation on the vehicle body.

In certain embodiments, each guide may further include an interface connecting the body panel and the flange.

In certain embodiments, the interface may define an arcuate inner wall to reduce stress concentrations.

In certain embodiments, the flange may extend in generally orthogonal relation to a width of the vehicle.

In certain embodiments, the flange may include a tapered configuration to inhibit vertical gapping with the vehicle body.

In certain embodiments, the flange may define a height that increases from a front end thereof towards a rear end thereof.

In another aspect of the present disclosure, a method is disclosed of inhibiting debris accumulation on a vehicle that includes a vehicle body and vehicle doors that are connected to the vehicle body. The method includes connecting air guides to the vehicle body such that flanges on the air guides extend axially between body panels of the air guides and sealing members that are positioned between the vehicle body and the vehicle doors, whereby the flanges inhibit debris from bypassing the air guides.

In certain embodiments, connecting the air guides to the vehicle body may include deforming the sealing members via engagement with the flanges.

In certain embodiments, connecting the air guides to the vehicle body may include positioning the air guides such that the flanges extend in generally parallel relation to a length of the vehicle.

In certain embodiments, connecting the air guides to the vehicle body may include receiving the vehicle body in recesses that are defined by the body panels and which are positioned laterally inward of the flanges.

In certain embodiments, connecting the air guides to the vehicle body may include positioning the air guides such that upper surfaces of the flanges mirror contours that are defined by the vehicle body to thereby inhibit vertical gapping between the air guides and the vehicle body.

### BRIEF DESCRIPTION OF THE DRAWINGS

According to common practice, the various features of the drawings may not be to scale and may be arbitrarily expanded or reduced for clarity.

FIG. 1 is a side, plan view of a vehicle including air guides according to the principles of the present disclosure.

FIG. 2 is a front, perspective view of one of the air guides.

FIG. 3 is a rear, perspective view of one of the air guides.

FIG. 4 is a bottom, perspective view of one of the air guides.

FIG. 5 is a cross-sectional view taken along line 5-5 in FIG. 1.

### DETAILED DESCRIPTION

The present disclosure describes air guides for a vehicle, each of which includes a body panel and a flange that extends outwardly from the body panel and in generally parallel relation to the length of the vehicle. The flanges are configured to interrupt airflow and thereby inhibit (if not entirely prevent) debris from bypassing (circumventing) the air guides and accumulating on the vehicle body. More specifically, upon connection of the air guides to the vehicle, the flanges are positioned within axial gaps that are defined between the body panels and sealing members on the vehicle, which are positioned between the vehicle body and the vehicle doors to thereby seal the vehicle doors upon closure.

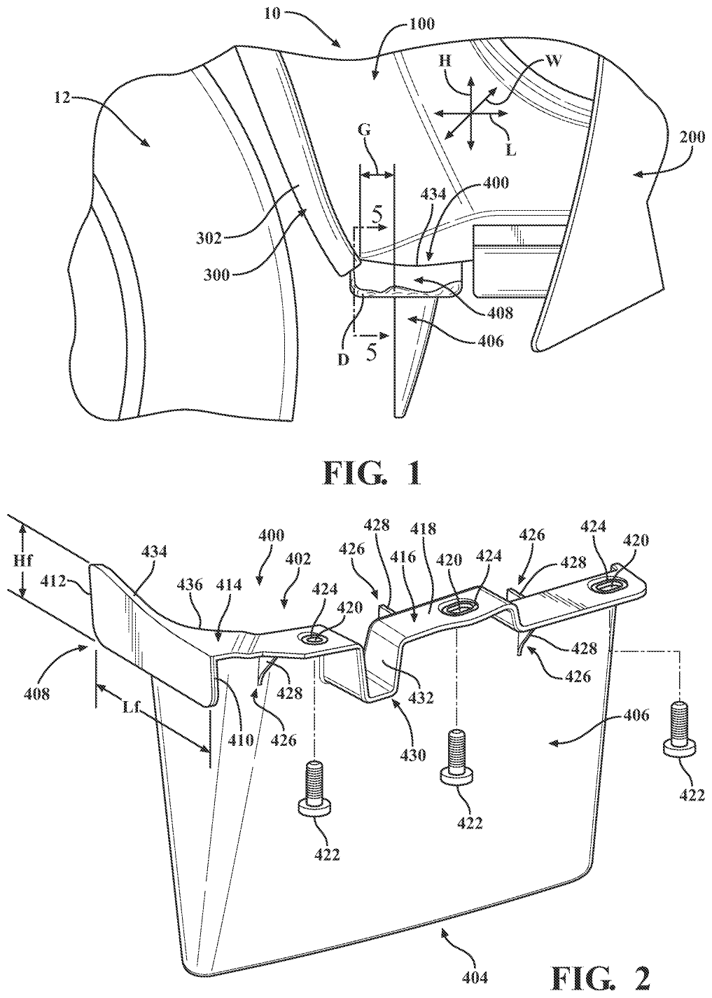

With reference to FIG. 1, a vehicle 10 is disclosed that includes: a vehicle body 100; vehicle doors 200 that are connected to the vehicle body 100; sealing members 300 (e.g., gaskets 302); and air guides 400, which are positioned (located) forwardly of rear wheels 12 of the vehicle 10. The vehicle doors 200, the sealing members 300, and the air guides 400 are positioned (located) on opposite sides of the vehicle 10 and are generally identical in configuration. As such, the vehicle doors 200, the sealing members 300, and the air guides 400 may be referred to herein in the singular form in the interests of brevity and clarity.

Although generally illustrated and described in the context of a passenger vehicle, it should be appreciated that the air guides 400 described herein may be configured for use with a wide variety of vehicles (e.g., trucks, SUVs, vans, buses, etc.).

The sealing members 300 are positioned (located) between the vehicle body 100 and the vehicle doors 200 such the vehicle doors 200 seal upon closure, which thereby inhibits (if not entirely prevents) the entry of air, water, etc., into the passenger cabin. Although the sealing members 300 are shown as being connected to (or otherwise supported by) the vehicle body 100, embodiments in which the sealing members 300 may be connected to (or otherwise supported by) the vehicle doors 200 are also envisioned herein and would not be beyond the scope of the present disclosure.

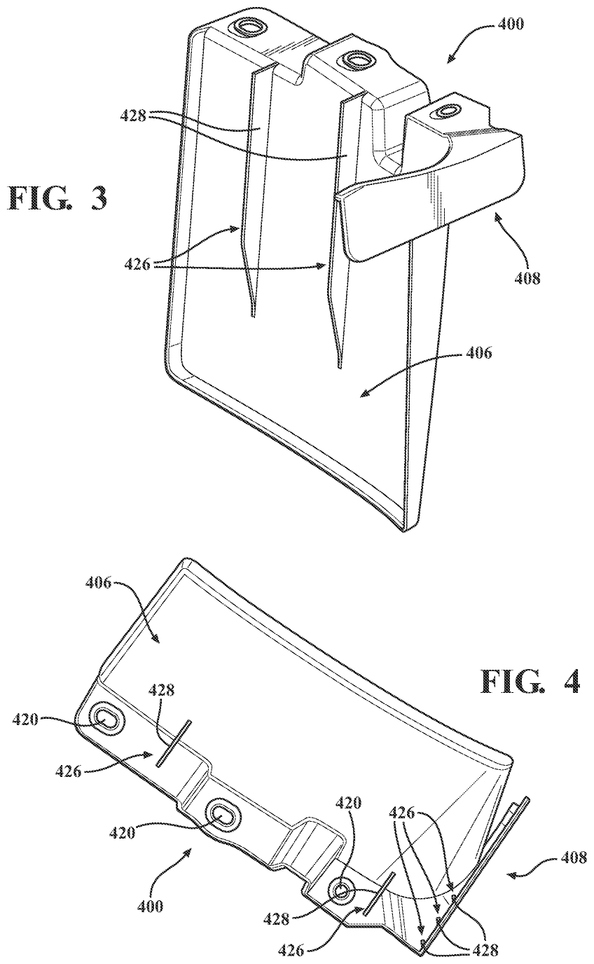

With reference to FIGS. 2-5 as well, the air guides 400 direct and route airflow around the rear wheels 12 of the vehicle 10 and each include: an upper (first) end 402; a free lower (second) end 404; a body panel 406; a flange 408, which defines opposite front (first) and rear (second) ends 410, 412, respectively; and an interface 414.

The air guide 400 is unitary (monolithic, integral) in construction and may be formed from a single piece of any suitable material. For example, in the illustrated embodiment, the air guide 400 includes a non-metallic material (e.g., (one or more) at least one polymeric material, (one or more) at least one composite material, etc.). Embodiments in which (one or more) at least one component of the air guide 400 may be formed as a separate, discrete structure are also envisioned herein, however, as are embodiments in which the air guides 400 may include one or more metallic materials, and would not be beyond the scope of the present disclosure.

The upper end 402 of the air guide 400 is connected (secured) to (or otherwise supported by) the vehicle body 100 and includes a mounting surface 416 (e.g., a lip 418). The mounting surface 416 includes (one or more) at least one opening 420 (FIGS. 2, 4) that is configured to receive a corresponding mechanical fastener 422 (FIG. 2) such that the mechanical fastener(s) 422 extend through the mounting surface 416 and into the vehicle body 100 to thereby connect the air guide 400 to the vehicle body 100. In the illustrated embodiment, the air guide 400 includes (one or more) at least one grommet 424, which is positioned (located) within (extends into) the opening(s) 420 in order to reduce wear on the air guide 400 and inhibit (if not entirely prevent) unintended disconnection of the air guide 400 from the vehicle body 100. Embodiments that are devoid of the grommet(s) 424 are also envisioned herein, however, and would not be beyond the scope of the present disclosure.

As seen in FIG. 1, upon connection of the air guide 400 to the vehicle body 100, the body panel 406 is spaced axially from the corresponding sealing member 300 along (i.e., in generally parallel relation to) a length L of the vehicle 10 such that an axial gap G (FIG. 1) is defined between the body panel 406 and the corresponding sealing member 300.

In the illustrated embodiment, the body panel 406 includes (one or more) at least one strengthening member 426 (e.g., a rib 428) (FIGS. 2-4), which extends vertically along (i.e., in generally parallel relation to) a height H (FIG. 1) of the vehicle 10 and is configured to increase the strength (rigidity) of the air guide 400, and (one or more) at least one (vertical) recess 430 (e.g., a clearance notch 432), which also extends along (i.e., in generally parallel relation to) the height H of the vehicle 10. The recess(es) 430 are positioned laterally inward of the flange 408 and are configured to receive the vehicle body 100 such that the vehicle body 100 extends into the air guide 400. Embodiments of the air guide 400 that are devoid of the strengthening member(s) 426 and/or the recess(es) 430 (e.g., depending upon the particular configuration of the vehicle body 100) are also envisioned herein, however, and would not be beyond the scope of the present disclosure.

The flange 408 extends axially in relation to the body panel 406 at the upper end 402 of the air guide 400 and defines a length Lf (FIG. 2). More specifically, the flange 408 extends along (i.e., in generally parallel relation to) the length L (FIG. 1) of the vehicle 10 and in generally orthogonal (perpendicular) relation to a width W of the vehicle 10.

The flange 408 is positioned (located) laterally outward of the strengthening member(s) 426 and the recess(es) 430 (i.e., such that the strengthening member(s) 426 and the recess(es) 430 are positioned laterally inward of the flange 408). The flange 408 is configured for positioning within the axial gap G such that the flange 408 extends between the body panel 406 and the sealing member 300, as seen in FIG. 1. By filling (occupying) the axial gap G, the flange 408 interrupts airflow around the air guide 400, which inhibits debris D from bypassing (circumventing) the air guide 400 and accumulating on the vehicle body 100.

The air guide 400 is configured such that the length Lf of the flange 408 lies substantially within the range of approximately 80 mm to approximately 120 mm. Embodiments in which the air guide 400 may be configured such that the length Lf of the flange 408 lies outside of the disclosed range are also envisioned herein, however, and would be beyond the scope of the present disclosure.

In the illustrated embodiment, the flange 408 defines a height Hf (FIG. 2) that varies between the ends 410, 412, thereof. More specifically, the flange 408 is configured such that the height Hf increases from the end 410 towards the end 412 and includes a tapered configuration, which not only increases the surface area that is available for the deflection of debris D (FIG. 1), but reduces (if not entirely eliminates) vertical gapping with the vehicle body 100 within the axial gap G (FIG. 1) (i.e., vertical spacing between the air guide 400 and the vehicle body 100). More specifically, as seen in FIG. 1, the flange 408 defines an upper surface 434 that extends continuously (i.e., in a non-interrupted fashion) between the ends 410, 412 of the flange 408 and includes a contour that mirrors (matches) that defined by the vehicle body 100.

In the illustrated embodiment, the air guide 400 is configured such that the height Hf of the flange 408 lies substantially within the range of approximately 35 mm to approximately 45 mm. Embodiments in which the air guide 400 may be configured such that the height Hf of the flange 408 lies outside of the disclosed range are also envisioned herein, however, and would be beyond the scope of the present disclosure.

The interface 414 (FIG. 2) extends laterally outward from the body panel 406 along (i.e., in generally parallel relation to) the width W (FIG. 1) of the vehicle 10 and is positioned (located) between and connects the body panel 406 and the flange 408. In addition to connecting the flange 408 to the body panel 406, the interface 414 introduces additional material to the air guide 400 that increases the strength (rigidity) thereof.

In order to reduce stress concentrations on the air guide 400 during operation of the vehicle 10, the interface 414 includes an arcuate (radiused, curved) inner wall 436.

Although illustrated and described as including the interface 414, embodiments of the air guide 400 that are devoid of the interface 414 (i.e., embodiments in which the flange 408 is directly connected to the body panel 406) are also envisioned herein and would not be beyond the scope of the present disclosure.

With reference now to FIGS. 1-5, methods of assembling the vehicle 10 and inhibiting the accumulation of debris D on the vehicle 10 will be discussed.

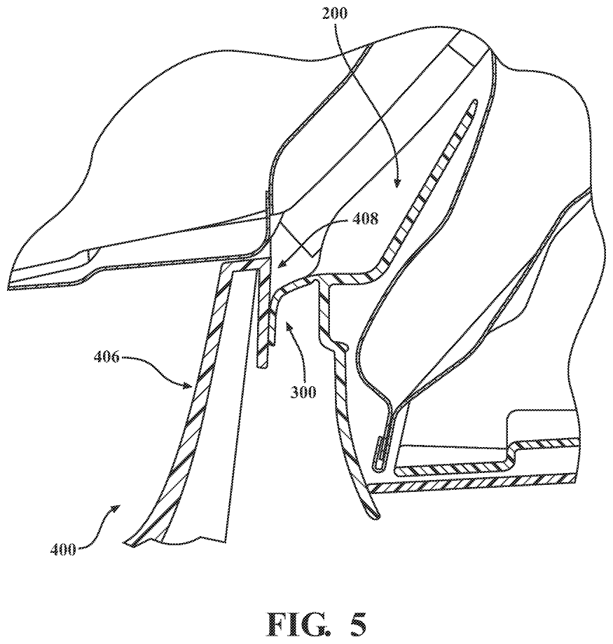

During assembly of the vehicle 10, the air guides 400 are positioned such that the flanges 408 extend in generally parallel relation to the length L of the vehicle 10, as seen in FIG. 1, and such that the vehicle body 100 is received by the recesses 430 (FIG. 2). As seen in FIG. 5, during installation of the air guides 400, the sealing members 300 are deformed (i.e., deflected, bent) via engagement with the flanges 408, whereby the flanges 408 sealingly engage (contact) the sealing members 300.

The upper ends 402 of the air guides 400 are then connected to the vehicle body 100 via insertion of the mechanical fasteners 422 (FIG. 2) through the openings 420 in the mounting surfaces 416, whereby the flanges 408 extends into the axial gaps G (FIG. 1) and axially between the body panels 406 and the sealing members 300, which inhibits debris D (FIG. 1) from bypassing the air guides 400 during operation of the vehicle 10 and, thus, the accumulation of debris D on the vehicle body 100. The matching contours defined by the upper surfaces 434 (FIGS. 1, 2) of the flanges 408 and the vehicle body 100 further inhibits the accumulation of debris D by reducing (if not entirely eliminating) vertical gapping between the air guides 400 and the vehicle body 100 within the axial gaps G.

Persons skilled in the art will understand that the various embodiments of the disclosure described herein and shown in the accompanying figures constitute non-limiting examples, and that additional components and features may be added to any of the embodiments discussed herein above without departing from the scope of the present disclosure. Additionally, persons skilled in the art will understand that the elements and features shown or described in connection with one embodiment may be combined with those of another embodiment without departing from the scope of the present disclosure and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments.

Use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°+25% (i.e., an angle that lies within the range of (approximately) 135° to (approximately)) 225° and the term “generally orthogonal” should be understood as referring to configurations in with the pertinent components are oriented so as to define an angle therebetween that is equal to 90°+25% (i.e., an angle that lies within the range of (approximately) 67.5° to (approximately)) 112.5°. The term “generally parallel” should thus be understood as referring to encompass configurations in which the pertinent components are arranged in parallel relation, and the term “generally orthogonal” should thus be understood as referring to encompass configurations in which the pertinent components are arranged in orthogonal relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A vehicle comprising:
a vehicle body;
vehicle doors connected to the vehicle body;
sealing members positioned between the vehicle body and the vehicle doors to thereby seal the vehicle doors upon closure; and
air guides connected to the vehicle body, wherein each air guide includes:
a body panel spaced axially from the corresponding sealing member along a length of the vehicle such that an axial gap is defined therebetween; and
a flange extending axially from the body panel at an upper end of the air guide, wherein the flange is configured for positioning within the axial gap to thereby inhibit debris accumulation on the vehicle body.

2. The vehicle of claim 1, wherein the air guides are unitary in construction.

3. The vehicle of claim 1, wherein the body panel includes at least one strengthening member extending vertically along a height of the vehicle, and the flange is positioned laterally outward of the at least one strengthening member.

4. The vehicle of claim 1, wherein the body panel includes at least one recess configured to receive the vehicle body, and the flange is positioned laterally outward of the at least one recess.

5. The vehicle of claim 1, wherein each air guide further includes:
an interface connecting the body panel and the flange.

6. The vehicle of claim 5, wherein the interface defines an arcuate inner wall to reduce stress concentrations.

7. The vehicle of claim 1, wherein the flange extends in generally orthogonal relation to a width of the vehicle.

8. The vehicle of claim 1, wherein the flange defines a height varying between a first end and a second end thereof.

9. The vehicle of claim 8, wherein the flange is configured such that the height increases from the first end towards the second end.

10. The vehicle of claim 9, wherein the flange includes a tapered configuration to inhibit vertical gapping with the vehicle body.

11. A vehicle comprising:
a vehicle body;
vehicle doors connected to the vehicle body;
sealing members positioned between the vehicle body and the vehicle doors to thereby seal the vehicle doors upon closure; and
air guides connected to the vehicle body, wherein each air guide includes:
a body panel; and
a flange connected to the body panel such that the flange extends between the body panel and the corresponding sealing member along a length of the vehicle to thereby inhibit debris accumulation on the vehicle body.

12. The vehicle of claim 11, wherein each guide further includes an interface connecting the body panel and the flange and defining an arcuate inner wall to reduce stress concentrations.

13. The vehicle of claim 11, wherein the flange extends in generally orthogonal relation to a width of the vehicle.

14. The vehicle of claim 11, wherein the flange includes a tapered configuration to inhibit vertical gapping with the vehicle body.

15. The vehicle of claim 14, wherein the flange defines a height that increases from a front end thereof towards a rear end thereof.

16. A method of inhibiting debris accumulation on a vehicle including a vehicle body and vehicle doors connected to the vehicle body, the method comprising:
connecting air guides to the vehicle body such that flanges on the air guides extend axially between body panels of the air guides and sealing members positioned between the vehicle body and the vehicle doors, whereby the flanges inhibit debris from bypassing the air guides.

17. The method of claim 16, wherein connecting the air guides to the vehicle body includes deforming the sealing members via engagement with the flanges.

18. The method of claim 16, wherein connecting the air guides to the vehicle body includes positioning the air guides such that the flanges extend in generally parallel relation to a length of the vehicle.

19. The method of claim 16, wherein connecting the air guides to the vehicle body includes receiving the vehicle body in recesses defined by the body panels and positioned laterally inward of the flanges.

20. The method of claim 16, wherein connecting the air guides to the vehicle body includes positioning the air guides such that upper surfaces of the flanges mirror contours defined by the vehicle body to thereby inhibit vertical gapping between the air guides and the vehicle body.
